(19) United States
(12) Patent Application Publication
(10) Pub. No.: US 2020/0027142 A1
(43) Pub. Date: Jan. 23, 2020

(54) SYSTEM AND METHOD FOR MARKETING THROUGH DIVISION OF PRODUCT GROUPS

(71) Applicant: Ho Kwang GU, Incheon (KR)

(72) Inventor: Ho Kwang GU, Incheon (KR)

(21) Appl. No.: 16/475,456

(22) PCT Filed: Nov. 22, 2017
(86) PCT No.: PCT/KR2017/013315

§ 371 Date: Jul. 2, 2019

(30) Foreign Application Priority Data
Jan. 4, 2017 (KR) 10-2017-0001225

(51) Int. Cl. G06Q 30/02; G06Q 30/06

(52) U.S. Cl. CPC G06Q 30/0283; G06Q 30/0601; G06Q 30/0201; G06Q 30/0276; G06Q 30/0223

(57) ABSTRACT

The present invention relates to a system and a method for marketing through the division of product groups. The system includes a management computer for providing online shopping mall related information through a web program or an application program outputted to or executed in at least one user terminal, wherein the management computer includes: a means for dividing information on products, which are on sale in the online shopping mall, into a general product group, which is set at a sales price lower than the market sales price, and a premium product group, and managing sales of corresponding products; a means for generating viral member group information on the basis of viral information of members of the online shopping mall and managing the same; and a means for allocating predetermined profits to a viral member group having purchased the product corresponding to the general product group.

### BACKGROUND OF THE INVENTION

### 1. Field of Invention

The present invention relates to a system and a method for marketing through the division of product groups. More specifically, the product groups sold in online shopping malls are divided into general product group and premium product group, while general product group are sold to consumers at lower prices than market prices. The difference between the market price and the sales price of the general product group is regarded as a marketing cost reduced to consumers and paid. It is an invention to sell a premium product group to a customer group secured through such marketing.

### 2. Description of Related Art

Online or offline sellers for merchandise sales usually have a huge marketing cost due to intense competition. Various methods are being developed to reduce the marketing cost and maximize the publicity effect. A typical example of such a marketing method is a multi-level sales or network sales method utilizing consumers. Multi-level marketing is a typical viral marketing method that can mobilize networking people without any additional marketing costs. However, multi-level sales are causing many social problems because of the increase in the economic and mental burden of the participants due to solicitation or forced sales. In addition, the multi-level sales method becomes burdensome and income-free as the lower-level participants in the multi-level system. For this reason, multilevel marketing is already being ignored by many consumers.

As an invention for solving such a problem, the invention of a home franchise merchant compensation system of Korean Patent Application Publication No. 10-2003-0091412 (published on Dec. 3, 2003) is disclosed.

The publication invention is an invention for preventing the harmfulness of the existing multi-level sales method, in which the profit distributions are evenly distributed from the lowest seller to the upper seller, thereby forcibly causing the sales to the lower seller.

However, in the above-mentioned publication invention, the structure of the multi-level sales person who has been recruited in multi-level sales raises the profit by becoming the seller. In the case of poor sales, there is a problem with the existing multi-level sales method in which a person belonging to a multi-level sales person must directly purchase expensive goods that do not need to raise their performance.

Therefore, the product groups sold at online shopping malls are divided into general product group and premium product group. Products of the general product group are sold to consumers at less than market price. The difference between the market price and the sales price of products of the general product group is regarded as the reduced marketing cost to the consumers who perform the viral communication or purchase the products of the general product group through the viral communication. In order to sell products of the premium product group to a consumer group secured on the basis thereof, there is a need for an invention relating to a marketing system and a method by dividing product groups.

### SUMMARY OF THE INVENTION

The present invention is intended to solve the problems of the prior art. An object of the present invention is to sell products sold in shopping malls separately from general product group and premium product group. The sales price of general product group is lower than the market price. Consumers who access these marketing methods spread the price information of the general product group purchased through social networks. The online shopping mall generates the groups of the consumers secured by the marketing method, and uses them for marketing.

Another object of the present invention is to spread the price information of the general product group by viral communication, and if the general product group is sold through the viral communication, a certain amount of the sales amount is regarded as the advertisement cost of the corresponding product. The amount regarded as the advertisement cost will be paid to the members who made the viral communication.

As a technical solution for achieving the object of the present invention, as a first aspect of the present invention, there is provided a marketing system through dividing product group comprising: a management computer for managing the online shopping mall website or application program related web contents, the divided product group information for providing to the online shopping mall, the member information of the online shopping mall, the product sale information of the online shopping mall; at least one user terminal connected to the management computer through an online shopping mall website or an application program, for registering a viral communication such as divided product group information through a social network service and performing purchase of product at the online shopping mall; The management computer provides general product group information in which sales price lower than the market price is presented and a premium product group information in which the sales price of the market price is presented. The users of the user terminal spread the viral communication through the social network service or the like via the general product group information having the low sales price to perform the publicity. And the management computer generates and manages groups for each level of consumers using viral communication information.

In a second aspect of the present invention, connecting, by a user terminal, a management computer and joining as a member of an online shopping mall sales divided product groups; storing, by the management computer, a user information of the user terminal as the member A1 of the online shopping mall; transmitting, by the user terminal, a viral communication data inputted by the member A1 in which related to divided product groups or information of the online shopping mall to the management computer or the external online media (A1 SNS); storing, by the management computer, as a member of a viral communication level A1 member who posted the viral communication data based on information of the viral communication data transmitted from the user terminal; receiving, by other user terminal, the viral communication data in which the online media (A1 SNS) provides to the other user terminal connected; connecting, by the other user computer, the management computer based on information included in the viral communication data and joining as a member of the online shopping mall; storing, by the management computer, as a member of at least one of members A11 to A1n the user information of at least one of other user terminal which has joined as a member of the online shopping mall; transmitting, by at least one of the other user terminal, a viral communication data inputted by at least one of members A11 to A1n in which related to divided product groups or information of the online shopping mall to the management computer or the external online media (at least one of SNSs A11 to A1n); storing, by the management computer, as a member of a viral communication level A2 member who posted the viral communication data based on information of the viral communication data transmitted from at least one of the other user terminal; receiving, by another user terminal, the viral communication data in which the online media (at least one of SNSs A11 to A1n) provides to at least one of the another user terminal connected; connecting, by the another user computer, the management computer based on information included in the viral communication data and joining as a member of the online shopping mall; storing, by the management computer, as a member of at least one of members A111 to A11n the user information of at least one of another user terminal which has joined as a member of the online shopping mall; transmitting, by at least one of the another user terminal, a viral communication data inputted by at least one of members A111 to A11n in which related to divided product groups or information of the online shopping mall to the management computer or the external online media (at least one of SNSs A111 to A11n); storing, by the management computer, as a member of a viral communication level A3 member who posted the viral communication data based on information of the viral communication data transmitted from at least one of the another user terminal; repeating, by the management computer, storing the viral communication levels A up to a predetermined number of levels; generating and storing, by the management computer, as an information of a viral communication group A based on stored whole information of the viral communication level A.

### Advantageous Effects

The present invention has the following effects. The products sold in the online shopping mall are divided into the general product group and the premium product group, and the sales price of the general product group is set to be lower than the market price to induce the viral communication through the social network of the consumers, It is possible to create a group for each level and utilize it for marketing.

Furthermore, the consumers spread the price information of the general product group by viral communication, and if the general product group is sold through the viral communication, a certain amount of the sales amount is regarded as the advertisement cost of the corresponding product. The amount regarded as the advertisement cost will be paid to the members who made the viral communication.

### BRIEF DESCRIPTION OF THE DRAWINGS

FIG. 1 is a diagram showing a marketing system through division of product groups according to an embodiment of the present invention;

FIG. 2 is a diagram showing an embodiment of a management computer which is a major component of a marketing system through division of product groups of the present invention;

FIG. 3 is a diagram showing an embodiment of a member information management module of a management computer which is a major component of marketing system through division of product groups of the present invention;

FIG. 4 is a diagram showing an embodiment of a product group information management module of a management computer which is a major component of marketing system through division of product groups of the present invention;

FIG. 5 is a diagram showing an embodiment of a content storage which is a major component of marketing system through division of product groups of the present invention;

FIG. 6 is an exemplary diagram illustrating how a membership group is created for each level in a marketing system through division of product groups according to the present invention.

FIG. 7 is a flowchart for explaining an embodiment of a marketing method through product group division according to the present invention.

FIG. 8 is a flowchart for explaining another embodiment of a marketing method through product group division according to the present invention.

### DETAILED DESCRIPTION OF THE PREFERRED EMBODIMENTS

Hereinafter, embodiments of the present invention will be described in detail with reference to the accompanying drawings.

For reference, in describing the embodiments of the present invention, each component described may be a part of a web program, an application program, or the like that utilizes hardware resources, or may be a hardware configuration.

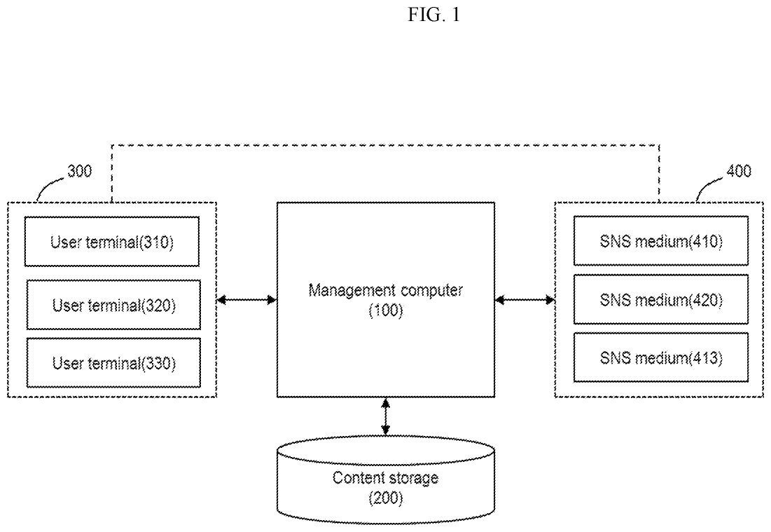

FIG. 1 is a diagram showing a marketing system through division of product groups according to an embodiment of the present invention.

As shown in FIG. 1, the marketing system through product group division according to the present invention comprises: a management computer 100 managing an online shopping mall website, application program related web contents, information on separated product groups for providing to the online shopping mall, member information of the online shopping mall, merchandise sales information of a shopping mall and viral information of members; a content storage 200 for storing various contents included in or connected to the management computer 100 and for providing various contents to a user terminal or the like through the management computer 100; at least one user terminal 300 connected to the management computer 100 through the online shopping mall website or the application program and registering viral information such as product information through a social network service and performing purchase of products at the online shopping mall; at least one social network service media (SNS media) 400 for displaying viral data regarding a product or an online shopping mall of the management computer 100 input from the at least one user terminal 300; wherein the management computer 100 provides general product group information of lower sales price than the market price and premium product group information of sales price of the market price, the users of the user terminal 300 perform the publicity by spreading the viral information through the social network service of the general product group information of lower sales price than the market price, and the management computer generates and manages groups for each level of consumers using the viral information.

The management computer 100 may be configured as a server computer in which includes various computer programs and data storage means necessary for the operation of the system of the present invention. The management computer 100 is connected to the user terminal 300 and the SNS media 400 by mobile or wireless Internet communication.

The user terminal 300 may be a notebook computer, a smart phone or tablet computer which can communicate with the management computer 100 using a communication means such as the Internet and can execute a web program or an application program.

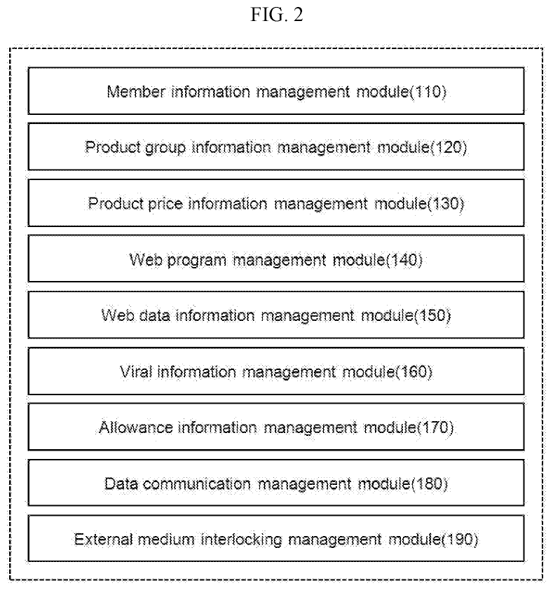

FIG. 2 is a diagram showing an embodiment of a management computer which is a major component of a marketing system through division of product groups of the present invention.

As shown in FIG. 2, the management computer of the present invention comprises: a member information management module 110 for accessing the management computer 100 through a web service or application program provided by the management computer 100 and managing user information of the user terminal 300 subscribed to the management computer 100; a product group information management module 120 for separately managing product groups of the online shopping mall to be provided to the user terminal 300 into general product groups and premium product groups; a product price information management module 130 for managing the sales price of the general product group and the premium product group managed by the product group information management module 120; a web program management module 140 for managing a web program such as an online shopping mall to be provided to the user terminal 300; a web data information management unit 150 for managing various data to be provided to a web program or an application program of an online shopping mall to be provided to the user terminal 300; a viral information management module 160 for managing information such as vital data registered by a member of the management computer 100 in an external media such as an SNS media; an allowance information management module 170 for calculating and managing an allowance to be allocated according to a purchase result of the general product group of members belonging to the viral group; a data communication module 180 for performing data communication with the user terminals 300; an external media interlocking management module 190 for interlocking with external media such as the SNS to register the viral data inputted from the user terminals 300.

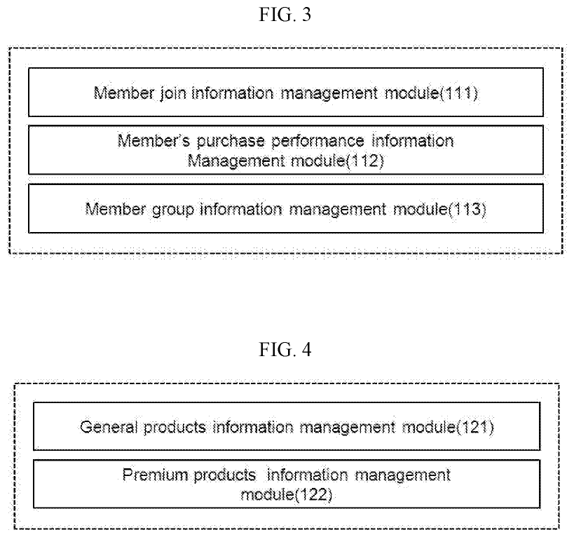

FIG. 3 is a diagram showing an embodiment of the member information management module which is a major component of the management computer of a marketing system through division of product groups of the present invention.

As shown in FIG. 3, the member information management module 110 of the present invention comprises: a member join information management unit 111 for managing the user information of the user computer 300 who joined member to the online shopping mall of the management computer 100; a member purchase performance information management unit 112 for managing purchase performance information of the general product group and the premium product group of the members and setting value information set in the online shopping mall where the members are paid for the purchase of the general product group; a member group information management unit 113 for managing the viral group information generated by registering the online shopping mall and product-related viral data on an external media such as an SNS media.

FIG. 4 is a diagram showing an embodiment of a product group information management module of a management computer which is a major component of marketing system through division of product groups of the present invention.

As shown in FIG. 4, the product group information management module 120 of the present invention comprises: a general product information management unit 121 for managing general product group information for which the sales price is set lower (for example, setting the sales margin to zero) than the sales price of the same product. the lower price of the general product is generated by minimizing the distribution stage of the product and by direct trading between the consumer and the producer; a premium product information management unit 122 for managing the premium product group information distinguished from the general product group, which is set as a sales price for the same product.

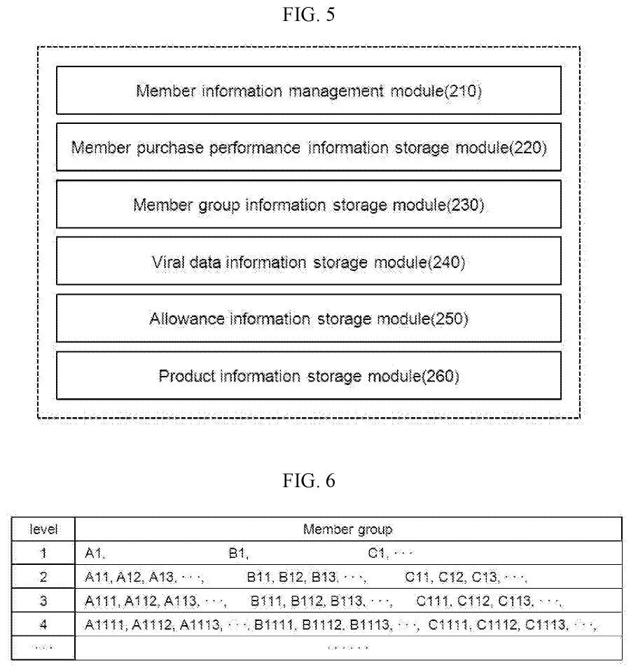

FIG. 5 is a diagram showing an embodiment of a content storage which is a major component of marketing system through division of product groups of the present invention.

As shown in FIG. 5, the content storage 200 of the present invention comprises: a member information storage module 210 for storing user information of the user terminal 300 registered as a member of the online shopping mall; a member purchase performance information storage module 220 for storing purchase performance information of the general product group and the premium product group purchased by the members in the online shopping mall and purchase setting value information set by the members as conditions for receiving the payment; a member purchase performance information storage module 220 for storing purchase setting value information related to a payment to be paid in accordance with purchasing of a general product group of members and performing the viral communication; a member group information storage module 230 for managing the viral group information generated by registering the online shopping mall and product related viral data on an external media such as an SNS media; a viral data information storage module 240 for storing the online shopping mall and product-related viral data information registered by the members on an external media such as an SNS media; an allowance information storage module 250 for storing allowance information allocated to members corresponding to the member group; a product information storage module 260 separately stored in a general product group and a premium product group for sales in the online shopping mall.

An embodiment of the marketing system through product group division of the present invention will be described in more detail with reference to FIGS. 1 to 5.

The general product group and the premium product group information divided in the product group information management unit 120 of the management computer 100 are registered as sales products in the online shopping mall. The marketing strategy of the online shopping mall is known to the consumer or members. For example, in the marketing strategy, the general product group is configured such that the sales price is lower than the sales price of the discount supermarket in the market, so that the consumer can purchase the product without the burden of price. In addition, the premium product group divided from the general product group is configured so that there is no difference from the sales price on the market. In the online shopping mall, a payment is made to the purchasing members of the general product group, and the members must belong to a predetermined viral group. Even if they belong to the viral group, In order to receive payment of the allowance, in the online shopping mall, there should be an achievement in which a member purchases a general product group with a predetermined amount or more and a premium product group with a predetermined amount or more. For example, only those members who belong to the member group who purchase a product corresponding to a general product group of 100,000 won (KRW) or more and a product of a premium product group of 50,000 won (KRW) or more can be paid. The purchase performance of these members is managed by the member purchase performance information management unit 112 included in the member information management unit 110 of the management computer 100. In addition, the allowance information management unit 170 can manage whether or not the members are to pay the allowance.

The condition for which the payment of the allowance is paid is not limited to this, but can be variously set based on the general product group and the premium product group.

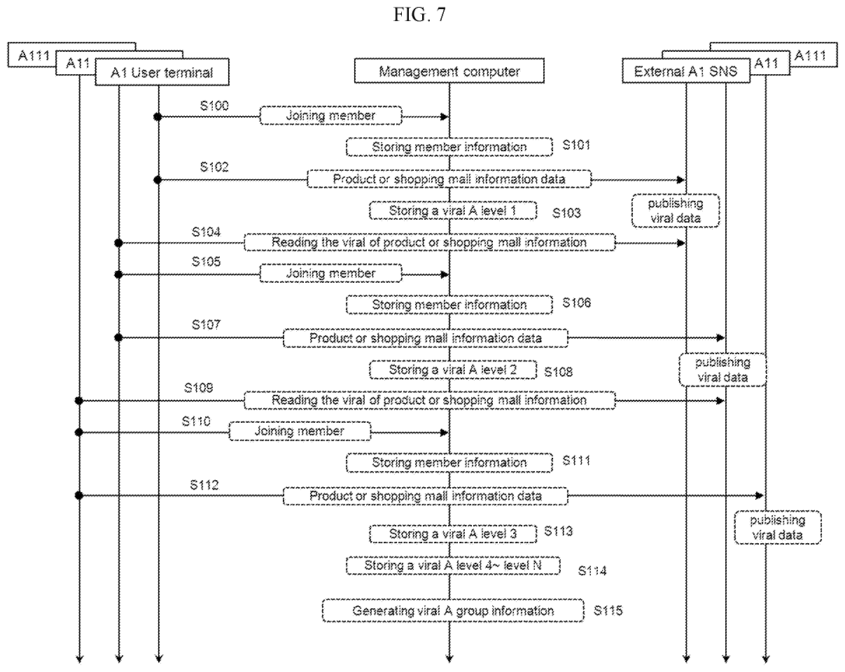

The generation of the member group in the present invention will be described. FIG. 6 is an exemplary diagram illustrating how a membership group is created for each level in a marketing system according to the present invention.

A member who has made a membership in the online shopping mall registers a viral communication related to information on a marketing strategy of an online shopping mall and information on an online shopping mall on an SNS media used by the member.

The viral information management unit 160 of the management computer 100 receives and stores the viral communication data and registration information of the member, and the member group information management unit 113 of the member information management unit 110 registers the member as A1 in the level 1 row.

The management computer 100 is registered as level 2 member (for example A11, A12, A13, . . . ) who read the viral data of A1 in the SNS media of A1 and registers the members of the online shopping mall. For example member A11 of level 2 registers the viral data related to information on a marketing strategy of an online shopping mall and information on an online shopping mall on an SNS media used by the member. The management computer 100 is registered as level 3 member (for example A111, A112, A113, . . . ) who read the viral data of A11 in the SNS media of A11 and registers the members of the online shopping mall. For example member A111 of level 3 registers the viral data related to information on a marketing strategy of an online shopping mall and information on an online shopping mall on an SNS media used by the member. The management computer 100 is registered as level 4 member (for example A1111, A1112, A1113, . . . ) who read the viral data of A111 in the SNS media of A111 and registers the members of the online shopping mall. The management computer 100 can be set up in this way or it can create membership groups up to infinite level.

As described above, the member who registers the viral data directly in the SNS media used by member is registered at the level 1. The user who reads the viral communication data of the level 1 member and registers as a member in the online shopping mall is registered as the level 2. Thus, for example, it is created as a separate member group, such as a lower member group of an A1 member of level 1, a lower member group of a B1 member, and a lower member group of a C1 member.

An embodiment of calculating the allowance of members belonging to a member group generated in the embodiment of the present invention will be described. As one example, all members are not subject to payment of benefits if they belong to a viral related membership group, as described above.

The calculation of the allowance can be applied only to the purchase performance of the general product group. For example, the allowance calculation can be calculated as the difference between the sales price of a supermarket of the same product as that of the product belonging to the general product group and the sales price of the product of the general product group.

That is, when the sales price of general product X is 10,000 won (KRW) and the sales price of the same product of the supermarket is 13,000 won (KRW), the allowance paid to the members is 3,000 won (KRW). Therefore, when the level of the membership group is limited to 10, the allowance allocated for each level can be calculated to be 300 won (KRW). The allowance allocated to each level can be distributed to the members of the corresponding level, and the members can also be earned and used at the online shopping mall.

Here, the allowance can be regarded as the marketing cost saved by the online shopping mall operators by promoting the online shopping mall through the viral communication.

FIG. 7 is a flowchart for explaining an embodiment of a marketing method through product group division according to the present invention.

As shown in FIG. 7, the marketing method through product group separation of the present invention comprises: registering as member of online shopping mall, by a user of at least one user terminal, that sells products divided into a general product group whose sales price is cheaper than the market price and a premium product group of the market price (S100); storing the user information of the user terminal as the member (A1) by the management computer (S101); transmitting the viral communication data related to the products or shopping mall information of the online shopping mall inputted by the member (A1) to the management computer or the external online media (A1 SNS) (S102); storing, by management computer, as viral A level 1 the member (A1) posting the viral communication data information based on the viral communication data transmitted from the user terminals(S103); reading the viral communication data, by a user of at least one other user terminal, from the accessed the external online media(A1 SNS)(S104); registering as member of online shopping mall, by the user of at least one other user terminal, based on online shopping mall information included in the viral communication data (S105); storing as at least one member of members A11˜A1N, by management computer, the user information of at least one other user computer registered as member(S106); transmitting, by at least one other user terminal, the viral communication data related to the products or shopping mall information of the online shopping mall inputted by at least one member of the members A11˜A1N to the management computer or at least one the external online media (A11 SNS˜A1N SNS)(S107); storing, by management computer, as viral A level 2 the member (A11˜A1N) posting the viral communication data information based on the viral communication data transmitted from at least one other user terminal(S108); reading the viral communication data, by a user of at least one another user terminal, from the accessed the external online media(at least one A11 SNS˜A1N SNS)(5109); registering as member of online shopping mall, by the user of at least one another user terminal, based on online shopping mall information included in the viral communication data (S110); storing as at least one member of members A111˜A11N, by management computer, the user information of at least one another user computer registered as member(S111); transmitting, by at least one another user terminal, the viral communication data related to the products or shopping mall information of the online shopping mall inputted by at least one member of the members A111˜A11N to the management computer or at least one the external online media (at least one A111 SNS˜A11N SNS)(S112); storing, by management computer, as viral A level 3 the member (A111˜A11N) posting the viral communication data information based on the viral communication data transmitted from at least one another user terminal(S113); storing as the lower level of the upper level of the viral A up to the set number of levels, registered members through the viral communication data registered by the upper level of the viral A(S114); generating and storing viral A group information based on stored all viral A level information, after the storage of the viral A level is completed up to the level set by the management computer(S115).

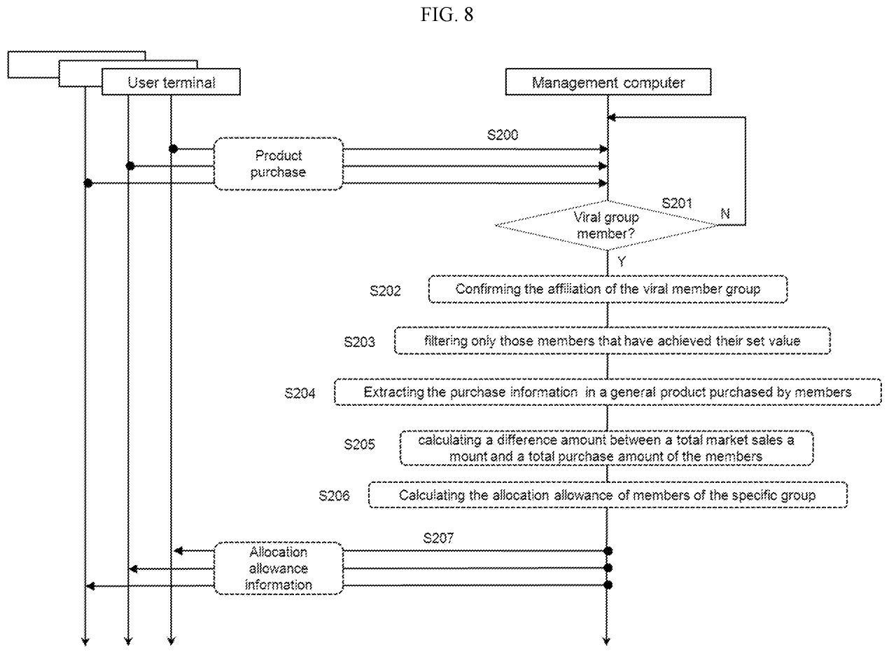

FIG. 8 is a flowchart for explaining another embodiment of a marketing method through product group division according to the present invention.

As shown in FIG. 8, the marketing method through product group separation of the present invention comprises: transmitting, by at least one user terminal, product purchase information of the members in the online shopping mall that sells products divided into a general product group whose sales price is cheaper than the market price and a premium product group of the market price to management computer (S200); confirming, by the management computer, whether the members of purchasing products corresponding to the general product group are members belonging to the viral member group generated for each level (S201); confirming, by management computer, the affiliation of the viral member group of the members, if the members who purchased the product corresponding to the general product group correspond to the viral group (S202); confirming, by the management computer, whether the members of the specific viral member group that have confirmed the affiliation has achieved a set value, and filtering only those members that have achieved their set value(S203); extracting, by the management computer, purchase information such as a product name, a number of purchase product and total purchase amount in a general product purchased by the members(S204); calculating, by the management computer, a difference amount between a total market sales amount of the same number of product and the same products as the general products purchased by the members based on the purchase information, and a total purchase amount of the members(S205); calculating, by the management computer, an allowance by dividing a difference amount between the total market sales amount and the total purchase amount by the number of members or the number of levels of the viral member group(S206); providing, by the management computer, the allocation allowance information to the user terminal of the members belonging to the viral member group(S207).

The embodiments of the present invention described above are only a few of various embodiments of the present invention. In the online shopping mall of the present invention, the general product group at a lower price than the market price and the premium product group at the market price are separately sold, and a member group is created on the basis of viral communication data by members with respect to the marketing strategy of payment of allowance according to the purchase performance of the general product group. Thus, it is natural that various embodiments included in the technical idea of increasing sales of online shopping malls are included in the protection scope of the present invention.

1. A system for marketing through division of product groups, the system including a management computer for providing online shopping mall related information through a web program or an application program outputted to or executed in at least one user terminal,
wherein the management computer comprises:
a member information management module for managing user information of the user terminal joined to the online shopping mall of the management computer;
a product group information management module for dividing and managing the products registered in the online shopping mall into a general product group and a premium product group;
a product price information management module for managing sales price information of the general product group and market sales price information of the premium product group;
a viral information management module for managing information such as viral communication data posted by a viral member group registered as a member of the management computer on a media such as a social network service (SNS); and
an allowance information management module for calculating and managing an allowance to be allocated according to a purchase performance of the general product group of the members belonging to a viral member group,
wherein the management computer provides the general product group in which a sales price is lower than a market sales price and the premium product group information in which a market sales price is presented,
wherein the users of the user terminal perform publicity by posting the viral communication data related to the online shopping mall information including the general product information of a lower sales price, and
wherein the management computer generates and manages a group for each level of consumers using the viral communication data information.

2. The system of claim 1, wherein the sales price of the general product group is lower than the average sales price of the large discount mart.

3. The system of claim 1, wherein the viral member group is generated based on the members which registered to external media the viral communication data corresponding to the at least one information of the online shopping mall information, the sales price information of the general product group and the predetermined allowance information.

4. The system of claim 1, wherein the predetermined allowance to be allocated to the viral member group is characterized in that it is calculated based on the purchase performance regarding the general product group of the members belonging to the viral member group.

5. The system of claim 1, wherein the predetermined allowance given to the viral member group is set based on the difference between the sales price of the product corresponding to the general product group and the average sales price of the large discount mart for the same product.

6. The system of claim 1, wherein the viral member group is generated by leveling the members in the order in which the members are registered in the online shopping mall by posting to the viral communication data based on the member who first posted the viral communication data in the media.

7. The system of claim 1, wherein the general product group should be constructed to the shortest distribution stage through direct dealing of product with consumers and minimize the sales price through the shortest distribution stage.

8. A method for marketing through division of product groups, the method comprising:
receiving, by a product group information management module, information on two product groups of a general product group and a premium product group;
receiving, by a product price information management module, a sales price information of the products belonging to the general product group set at a lower sales price than the market price and a sales price information of the products belonging to the premium product group set at the market price;
registering, by a management computer, product information of the general product group having sales price information lower than the market price and product information of the premium product group having sales price information at a market price so as to be exposed to an online shopping mall;
receiving, by the management computer, member registration information inputted by the at least one user terminal through the web program or the application program, wherein the online shopping mall displays the product information of the general product group and the product information of the premium product group;
storing, by the management computer, user information of the user terminal registered the member of the online shopping mall;
registering, by the user terminal, a viral communication data inputted by the member to the management computer or external media, wherein the viral communication data is shopping mall information including information on products lower than the market price belonging to the general product group of the online shopping mall;
storing as an upper level member of the viral member group, by the management computer, a member who posted the viral communication data;
storing as a lower member of the viral member group, by the management computer, a member who joined as a member through the viral communication data of the upper level member of the online shopping mall and posted a viral communication data related to sales price of general product of online shopping mall to the management computer or external media;
continuing the process of storing as a next lower level member, by the management computer, a member who joined as a member through the viral communication data of the lower level member of the online shopping mall and posted a viral communication data related to sales price of general product of online shopping mall to the management computer or external media; and
generating and storing a viral member group information on the basis of the stored whole level information, after the management computer has stored the member information of the level of the viral member group until the number of levels set by the management computer is completed.

9. A method for marketing through division of product groups, the method comprising:
receiving, by a product group information management module of a management computer, two product groups information of a general product group and premium product group;
receiving, by a product group information management module of the management computer, sales price information of products belonging to the general product group which is set at a sales price lower than the market price and sales price information of the products belonging to the premium product group which is set at the market price;
registering, by the management computer, the product information of the general product group which is set at a sales price lower than the market price and the product information of the premium product group which is set at the market price so that the products information is exposed to the online shopping mall;
receiving, by management computer, information of joining member of the online shopping mall inputted through web program or application program of at least one user terminal;
posting, by the user terminal, a viral communication data related to the information of online shopping mall including information of the sales prices of the general product lower than the market price to the management computer or external media;
storing as a upper level member of a viral member group, by the management computer, a member who posted a viral communication data;
storing as a lower member of the viral member group, by the management computer, a member who joined as a member through the viral communication data of the upper level member of the online shopping mall and posted a viral communication data related to sales price of general product of online shopping mall to the management computer or external media;
continuing the process of storing as a next lower level member of the viral member group, by the management computer, a member who joined as a member through the viral communication data of the lower level member of the online shopping mall and posted a viral communication data related to sales price of general product of online shopping mall to the management computer or external media;
confirming, by the management computer, whether the member who has purchased the product corresponding to the general product group is a member who belongs to the viral member group generated according to the level;
confirming, by the management computer, the affiliation of the viral member group of the members, if the members who purchased the product of the general product group correspond to the viral member group;
confirming, by the management computer, whether the members of the viral member group that have confirmed the affiliation has achieved a set value, and filtering only those members that have achieved their set value;
extracting, by the management computer, purchase information such as a product name, a number of purchase product and total purchase amount in a general product purchased by the members;
calculating, by the management computer, a difference amount between a total market sales amount of the same number of product and the same products as the general products purchased by the members based on the purchase information, and a total purchase amount of the general product of the members;
calculating, by the management computer, a difference amount between the total market sales amount and the total purchase amount as the allowance of the viral member group; and
providing, by the management computer, the allocation allowance information to the user terminal of the members belonging to the viral member group.

10. The method of claim 9, wherein the calculating of allowance for the viral member group is performed by dividing the difference amount between the total market sales amount and the total purchase amount by the number of members belonging to the viral member group or by dividing the difference amount by the number of levels set in the viral member group.
